(19) United States
(12) Patent Application Publication
(10) Pub. No.: US 2025/0385505 A1
(43) Pub. Date: Dec. 18, 2025

(54) OPEN-PHASE FAULT AND SECONDARY ARC EXTINCTION DETECTION IN ELECTRIC POWER SYSTEMS

(71) Applicant: Schweitzer Engineering Laboratories, Inc., Pullman, WA (US)

(72) Inventors: Sajal Harmukh, Pullman, WA (US); David Schmidt, Athens, GA (US); Emma Clawson, Pullman, WA (US)

(73) Assignee: Schweitzer Engineering Laboratories, Inc., Pullman, WA (US)

(21) Appl. No.: 19/237,508

(22) Filed: Jun. 13, 2025

Related U.S. Application Data
(60) Provisional application No. 63/660,239, filed on Jun. 14, 2024.

(51) Int. Cl. H02H 1/00; H02H 3/06; H02H 3/13

(52) U.S. Cl. CPC H02H 1/0007; H02H 3/06; H02H 3/13

(57) ABSTRACT

Systems, methods, and devices presented herein are directed toward detecting a secondary arc extinction (SAE). SAE detection circuitry may identify the presence of arcing and bolted faults that persist through the end of a dead time (e.g., a predetermined time period between detection of a secondary arc and auto-reclosing). The SAE detection circuitry may detect the extinction of secondary arcing prior to the dead time expiring and provide output signals that may enable reclosing prior to the expiration of the dead time when secondary arc extinction is detected or to block reclosing when the secondary arc is still present at the end of the dead time. Further, the SAE detection circuitry may be implemented for transposed, untransposed, compensated, and uncompensated lines.

### CROSS-REFERENCE TO RELATED APPLICATIONS

This application is a continuation of U.S. Provisional Patent Application No. 63/660,239 filed Jun. 14, 2024, entitled “Open-Phase Fault Detection to Prevent Single-Pole Reclosing Onto Existing Faults,” which is hereby incorporated by reference in its entirety for all purposes.

### BACKGROUND

This disclosure relates to protection devices in an electric power delivery system. More particularly, this disclosure relates to detecting open-phase faults and secondary arc extinction in an electric power system.

A single-line-to-ground (SLG) fault is the most common fault-type in power systems. Because most SLG faults are temporary, single-pole tripping (SPT) and auto-reclosing are commonly used to maintain continuity of service through the healthy phases (e.g., non-faulting phases) of a three-phase system, improve transient system stability, and allow a temporary fault to clear before reclosing. It is beneficial for a fault to clear prior to reclosing, as reclosing prior to extinction of the secondary arc may enable the fault to persist.

In some instances, reclosing schemes may incorporate a dead time (e.g., a length of time between single-pole tripping and auto-reclosing). That is, the recloser will close at the end of the dead time, enabling current to flow on the faulted phase. The dead time is an estimate to allow secondary arcs to extinguish and dielectric strength to build sufficiently to withstand full nominal phase voltage. However, in some instances, the dead time may be longer than the time it takes for the secondary arcs to extinguish, resulting in additional downtime. Conversely, the fault may be permanent, or the secondary arcing may persist beyond the dead time.

Secondary arcing refers to a sustained arcing through an ionized channel, which persists after the primary fault current has been cleared by isolating the faulted phase using single-pole tripping. The secondary arc may persist due to capacitive and inductive coupling from the healthy phases. Several techniques have been employed to mitigate secondary arcing and reduce the secondary arc extinction (SAE) time. For example, a four-legged shunt reactor with a neutral reactor may be deployed in transposed line applications. For untransposed lines, a compensation scheme may be used where a modified four-legged shunt reactor is used in conjunction with a simple four-legged shunt reactor. Transposition, as used herein, refers to the periodic swapping of positions of the conductors of a transmission line to reduce coupling, reduce imbalance or otherwise improve transmission performance. Transmission lines with either type of shunt reactor compensation may be referred to herein as compensated lines, and lines without shunt reactors may be referred to herein as uncompensated lines. While several solutions have been proposed to detect secondary arc extinction, many existing approaches have substantial drawbacks—such as assuming a transposed line, assuming an uncompensated line, and/or ignoring line loading.

### BRIEF DESCRIPTION OF THE DRAWINGS

FIG. 1 is a schematic diagram of an embodiment of an electric power delivery system, in accordance with an embodiment of the present disclosure;

FIG. 2 is a schematic diagram of an embodiment of a computing system that may be incorporated in a component of the electric power delivery system, in accordance with an embodiment of the present disclosure;

FIG. 3 is a schematic diagram of an uncompensated three-phase transmission line wherein one of the phases is open, in accordance with an embodiment of the present disclosure;

FIG. 4 is a flow diagram illustrating the operation of secondary arc extinction (SAE) detection circuitry that may be used to detect secondary arc extinction in the uncompensated transmission line of FIG. 3, in accordance with an embodiment of the present disclosure;

FIG. 5 is a plot that illustrates the underlying principle of SAE detection for the uncompensated transmission line of FIG. 3 via the SAE circuitry of FIG. 4, in accordance with an embodiment of the present disclosure;

FIG. 6 is a logic diagram of the SAE detection circuitry of FIG. 4 illustrating the conditions under which the SAE detection circuitry may output the SAE detection signal and enable a recloser to reclose, in accordance with an embodiment of the present disclosure;

FIG. 7 is a logic diagram of the SAE detection circuitry of FIG. 4 illustrating the conditions under which the SAE detection circuitry may output the block reclose signal and prevent the recloser from reclosing, in accordance with an embodiment of the present disclosure;

FIG. 8 is a flow diagram illustrating the operation of the SAE detection circuitry in an uncompensated transmission line using extended unipolar DC detection, in accordance with an embodiment of the present disclosure;

FIG. 9 is a schematic diagram of a compensated transmission line having a four-legged shunt reactor, in accordance with an embodiment of the present disclosure;

FIG. 10 is a flow diagram illustrating the operation of SAE detection circuitry for compensated transmission lines, such as the compensated transmission line of FIG. 9, in accordance with an embodiment of the present disclosure;

FIG. 11 is a logic diagram of the SAE detection circuitry 416 of FIG. 10 illustrating the conditions under which the SAE detection circuitry may output the SAE detected signal and enable reclosing in the compensated transmission line of FIG. 9, in accordance with an embodiment of the present disclosure;

FIG. 12 is a logic diagram of the SAE detection circuitry 416 of FIG. 10 illustrating the conditions under which the SAE detection circuitry may output the block reclose signal and prevent reclosing in the compensated transmission line of FIG. 9, in accordance with an embodiment of the present disclosure;

FIG. 13 is a plot illustrating straight ringing of an open-phase voltage signal in the compensated transmission line of FIG. 3, in accordance with an embodiment of the present disclosure; FIG. 14 is a plot illustrating downward ringing of an open-phase voltage signal in the compensated transmission line of FIG. 9, in accordance with an embodiment of the present disclosure;

FIG. 15 is a diagram of a transmission line having a 3-legged shunt reactor with a solidly grounded neutral, in accordance with an embodiment of the present disclosure;

FIG. 16 is a logic diagram illustrating the operation of the SAE detection circuitry that may be implemented for the uncompensated transmission lines of FIG. 3, transmission lines compensated with the 4-legged shunt reactor of FIG. 9, and transmission lines compensated with the 3-legged shunt reactor of FIG. 15, in accordance with an embodiment of the present disclosure; and

FIG. 17 is a logic diagram illustrating a combined algorithm that may block reclosing for uncompensated lines of FIG. 3, the shunt-reactor compensated lines with 4-legged reactors of FIG. 9, and the shunt-reactor compensated lines with 3-legged reactors of FIG. 15, in accordance with an embodiment of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

With the foregoing in mind, systems and methods for reliable SAE detection during the single-pole open condition are disclosed herein. SAE detection circuitry disclosed herein may detect faults on an open phase by using local voltage and current measurements. Specifically, SAE detection circuitry may identify the presence of arcing and bolted faults that persist through the end of a dead time (e.g., a predetermined time period between single-pole tripping and auto-reclosing). A bolted fault may be defined as a short circuit fault caused by direct connection between conductors, creating a zero-impedance path for current flow. The SAE detection circuitry may detect the extinction of secondary arcing prior to the dead time expiring and provide output signals that may enable reclosing prior to the expiration of the dead time when secondary arc extinction is detected or to block reclosing when the secondary arc is still present at the end of the dead time. Further, the SAE detection circuitry may be implemented for transposed, untransposed, compensated, and uncompensated lines.

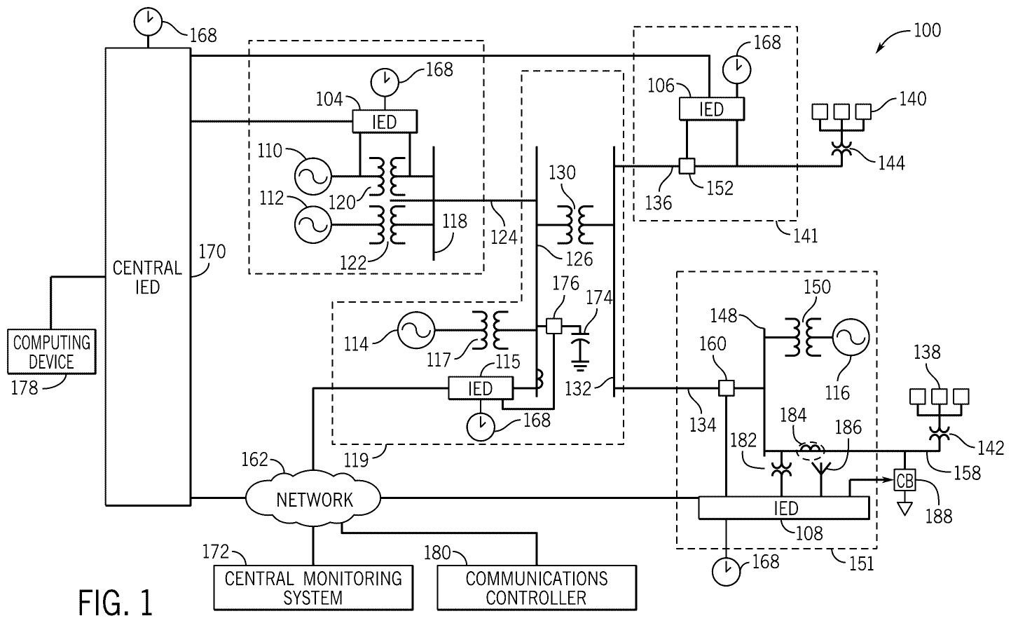

FIG. 1 illustrates a simplified diagram of an electric power delivery system 100, in accordance with an embodiment of the present disclosure. The electric power delivery system 100 may generate, transmit, and/or distribute electric energy to one or more loads. As illustrated, the electric power delivery system 100 includes electric generators 102, 104, 106, and 108. The electric power delivery system 100 may also include power transformers 110, 112, 114, 116, 118, 120, and 122. Furthermore, the electric power delivery system may include lines 124, 126, 128, and 130 to transmit and/or deliver power. Circuit breakers 132, 134, and 136 may be used to control flow of power in the electric power delivery system 100. Busses 138, 140, 142, and 144 and/or loads 146 and 148 receive the power in and/or from (e.g., output by) the electric power delivery system 100. A variety of other types of equipment may also be included in electric power delivery system 100, such as current sensors (e.g., wireless current sensor (WCS) 150), potential transformers (e.g., potential transformer 152), voltage regulators, capacitors (e.g., capacitor 154) and/or capacitor banks (e.g., capacitor bank (CB) 156), antennas (e.g., antenna 158), and other suitable types of equipment useful in power generation, transmission, and/or distribution.

A substation 160 may include the electric generator 106, which may be a distributed generator, and which may be connected to the bus 140 through the power transformer 110 (e.g., a step-up transformer). The bus 140 may be connected to a distribution bus 142 via the power transformer 116 (e.g., a step-down transformer). Various distribution lines 126 and 128 may be connected to the distribution bus 142. The distribution line 128 may be connected to a substation 162 where the distribution line 128 is monitored and/or controlled using an intelligent electronic device (IED) 164, which may selectively open and close the circuit breaker 132. A load 148 may be fed from the distribution line 128. The power transformer 120 (e.g., a step-down transformer), in communication with the distribution bus 142 via distribution line 128, may be used to step down a voltage for consumption by the load 148.

A distribution line 126 may deliver electric power to a bus 144 of a substation 166. The bus 144 may also receive electric power from a distributed generator 108 via transformer 122. The distribution line 130 may deliver electric power from the bus 144 to a load 146, and may include the power transformer 118 (e.g., a step-down transformer). A circuit breaker 134 may be used to selectively connect the bus 144 to the distribution line 126. The IED 168 may be used to monitor and/or control the circuit breaker 134 as well as the distribution line 130.

The electric power delivery system 100 may be monitored, controlled, automated, and/or protected using IEDs such as the IEDs 164, 168, 170, 172, and 174, and a central monitoring system 175. In general, the IEDs in an electric power generation and transmission system may be used for protection, control, automation, and/or monitoring of equipment in the system. For example, the IEDs may be used to monitor equipment of many types, including electric transmission lines, electric distribution lines, current sensors, busses, switches, circuit breakers, reclosers, transformers, autotransformers, tap changers, voltage regulators, capacitor banks, generators, motors, pumps, compressors, valves, and a variety of other suitable types of monitored equipment.

As used herein, an IED (e.g., the IEDs 164, 168, 170, 172, and 174) may refer to any processing-based device that monitors, controls, automates, and/or protects monitored equipment within the electric power delivery system 100. Such devices may include, for example, remote terminal units, merging units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, and the like. The term IED may be used to describe an individual IED or a system including multiple IEDs. Moreover, an IED of this disclosure may use a non-transitory computer-readable medium (e.g., memory) that may store instructions that, when executed by a processor of the IED, cause the processor to perform processes or methods disclosed herein. Moreover, the IED may include a wireless communication system to receive and/or transmit wireless messages from a wireless electrical measurement device. The wireless communication system of the IED may be able to communicate with a wireless communication system of the wireless electrical measurement devices, and may include any suitable communication circuitry for communication via a personal area network (PAN), such as Bluetooth or ZigBee, a local area network (LAN) or wireless local area network (WLAN), such as an 368.11c Wi-Fi network, and/or a wide area network (WAN), (e.g., third-generation (3G) cellular, fourth-generation (4G) cellular, universal mobile telecommunication system (UMTS), long term evolution (LTE), long term evolution license assisted access (LTE-LAA), fifth-generation (5G) cellular, and/or 5G New Radio (5G NR) cellular). In some cases, the IEDs may be located remote from the respective substation and provide data to the respective substation via long-distance communication (e.g., radio, a fiber-optic cable, a communications network).

A common time signal may be distributed throughout the electric power delivery system 100. Utilizing a common time source 176 may ensure that IEDs have a synchronized time signal that can be used to generate time synchronized data, such as synchrophasors. In various embodiments, the IEDs 164, 168, 170, 172, and 174 may be coupled to a common time source(s) 176 and receive a common time signal. The common time signal may be distributed in the electric power delivery system 100 using a communications network 178 and/or using a common time source 176, such as a Global Navigation Satellite System (“GNSS”), or the like.

According to various embodiments, the central monitoring system 175 may include one or more of a variety of types of systems. For example, the central monitoring system 175 may include a supervisory control and data acquisition (SCADA) system and/or a wide area control and situational awareness (WACSA) system. A central IED 174 may be in communication with the IEDs 164, 168, 170, and 172. The IEDs 164, 168, 170, and 172 may be located remote from the central IED 174, and may communicate over various media such as a direct communication from IED 164 or over the communications network 178. According to various embodiments, some IEDs may be in direct communication with other IEDs. For example, the IED 170 may be in direct communication with the central IED 174. Additionally or alternatively, some IEDs may be in communication via the communications network 178. For example, the IED 168 may be in communication with the central IED 174 via the communications network 178. In some embodiments, an IED may refer to a relay, a merging unit, or the like.

Communication via the communications network 178 may be facilitated by networking devices including, but not limited to, multiplexers, routers, hubs, gateways, firewalls, and/or switches. In some embodiments, the IEDs and the network devices may include physically distinct devices. In certain embodiments, the IEDs and/or the network devices may be composite devices that may be configured in a variety of ways to perform overlapping functions. The IEDs and the network devices may include multi-function hardware (e.g., processors, computer-readable storage media, communications interfaces, etc.) that may be utilized to perform a variety of tasks that pertain to network communications and/or to operation of equipment within the electric power delivery system 100.

A communications controller 180 may interface with equipment in the communications network 178 to create a software-defined network (SDN) that facilitates communication between the IEDs 164, 168, 170, 172, and 174 and the central monitoring system 176. In various embodiments, the communications controller 180 may interface with a control plane (not shown) in the communications network 178. Using the control plane, the communications controller 180 may direct the flow of data within the communications network 178.

The communications controller 180 may receive information from multiple devices in the communications network 178 regarding transmission of data. In embodiments in which the communications network 178 includes fiber optic communication links, the data collected by the communications controller 180 may include reflection characteristics, attenuation characteristics, signal-to-noise ratio characteristics, harmonic characteristics, packet loss statics, and the like. In embodiments in which the communications network 178 includes electrical communication links, the data collected by the communications controller 180 may include voltage measurements, signal-to-noise ratio characteristics, packet loss statics, and the like. In some embodiments, the communications network 178 may include both electrical and optical transmission media. The information collected by the communications controller 180 may be used to assess a likelihood of a failure, to generate information about precursors to a failure, and to identify a root cause of a failure. The communications controller 180 may associate information regarding a status of various communication devices and communication links to assess a likelihood of a failure. Such associations may be utilized to generate information about the precursors to a failure and/or to identify root cause(s) of a failure consistent with embodiments of the present disclosure.

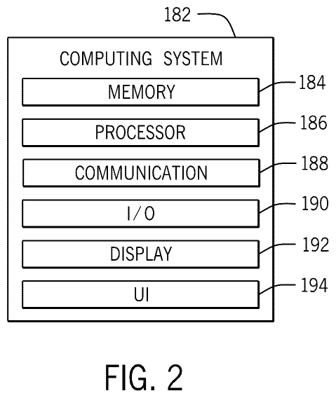

FIG. 2 is a schematic diagram of an embodiment of a computing system 182 that may be incorporated within a component of the electric power delivery system 100, such as in any of the IEDs 164, 168, 170, and/or 172. The computing system 182 may include a memory 184 and a processor or processing circuitry 186. The memory 184 may include a non-transitory computer-readable medium that may store instructions that, when executed by the processor 186, may cause the processor 186 to perform various methods described herein. To this end, the processor 186 may be any suitable type of computer processor or microprocessor capable of executing computer-executable code, including but not limited to one or more field programmable gate arrays (FPGA), application-specific integrated circuits (ASIC), programmable logic devices (PLD), programmable logic arrays (PLA), and the like. The processor 186 may, in some embodiments, include multiple processors.

The computing system 182 may also include a communication system 188, which may include a wireless and/or wired communication component to establish a communication link with another component of the electric power delivery system 100. That is, the communication system 188 enables the computing system 182 (e.g., of one of the IEDs 164, 168, 170, 172) to communicate with another communication system 188 of another computing system 182, such as via MACsec. Indeed, the communication system 188 may include any suitable communication circuitry for communication via a personal area network (PAN), such as Bluetooth or ZigBee, a local area network (LAN) or wireless local area network (WLAN), such as an 368.11x Wi-Fi network, and/or a wide area network (WAN), (e.g., third-generation (3G) cellular, fourth-generation (4G) cellular, near-field communications technology, universal mobile telecommunication system (UMTS), long term evolution (LTE), long term evolution license assisted access (LTE-LAA), fifth-generation (5G) cellular, and/or 5G New Radio (5G NR) cellular). The communication system 188 may also include a network interface to enable communication via various protocols such as EtherNet/IP®, ControlNet®, DeviceNet®, or any other industrial communication network protocol.

Additionally, the computing system 182 may include input/output (I/O) ports 190 that may be used for communicatively coupling the computing system 182 to an external device. For example, the I/O ports 190 of the computing system 182 may communicatively couple to corresponding I/O ports 190 of the computing system 182. The computing system 182 may further include a display 192 that may present any suitable image data or visualization. Indeed, the display 192 may present image data that includes various information regarding the electric power delivery system 100, thereby enabling the user to observe an operation, a status, a parameter, other suitable information, or any combination thereof, of the electric power delivery system 100. Further still, the computing system 182 may include a user interface (UI) 194 with which the user may interact to control an operation of the computing system 182. For instance, the UI 194 may include a touch screen (e.g., as a part of the display 192), an eye-tracking sensor, a gesture (e.g., hand) tracking sensor, a joystick or physical controller, a button, a knob, a switch, a dial, a trackpad, a mouse, another component, or any combination thereof.

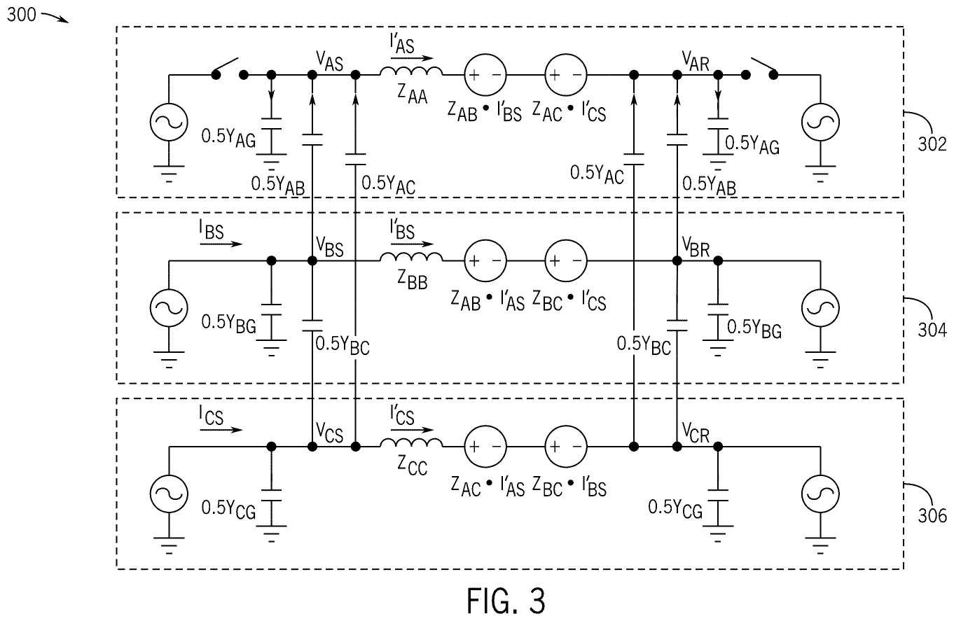

FIG. 3 is a schematic diagram of an uncompensated transmission line 300 (e.g., a 3-phase transmission line) including an A-phase 302, a B-phase 304, and a C-phase 306, wherein the A-phase 302 is open.

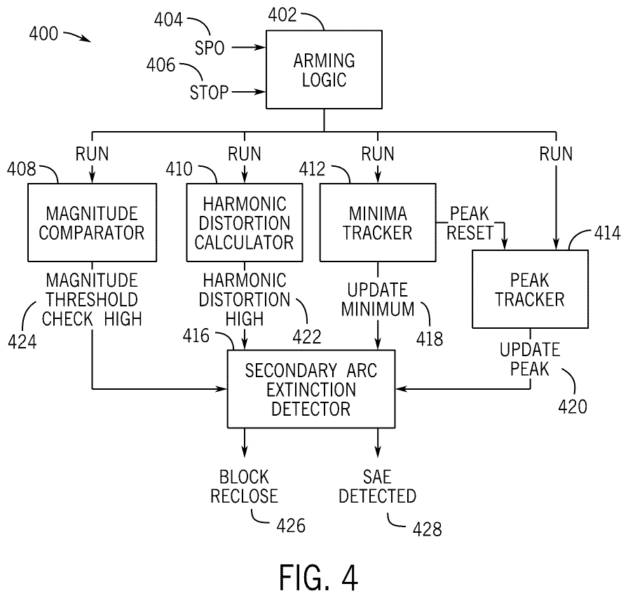

FIG. 4 is a flow diagram illustrating SAE detection circuitry 400 that may be used to detect secondary arc extinction in an uncompensated transmission line (e.g., a transmission line without shunt reactors) such as the uncompensated transmission line 300. A shunt reactor may be defined as a reactor (e.g., an inductor) coupled between phase and ground. The SAE detection circuitry 400 may include or be part of the computing system 182 (e.g., IEDs 164, 168, 170, 172, and 174, such as a relay). The SAE detection circuitry 400 may not be operational (e.g., running, performing SAE detection) at all times, and may only activate upon determining that the uncompensated transmission line 300 is in a single-pole open (SPO) state, as is illustrated in FIG. 3. The SAE circuitry 400 includes arming logic 402 to enable the SAE detection circuitry 400 upon receiving an asserted SPO bit 404, wherein the asserted SPO bit 404 indicates that the transmission line 300 is in the SPO state. The arming logic 402 may also deactivate the SAE detection circuitry 400 to cause the SAE detection circuitry 400 to stop the SAE detection upon receiving an asserted STOP bit 406. The asserted STOP bit 406 may include a “close” signal received at the SAE detection circuitry 400 from a recloser.

The SAE detection circuitry 400 includes a magnitude comparator 408, a harmonic distortion calculator 410, a minima tracker 412, a peak tracker 414, and secondary arc extinction (SAE) detector 416. As will be described in greater detail below, the SAE detection circuitry 400 will detect an SAE based on the voltage and current signals present in the uncompensated transmission line 300 during a fault event and a secondary arc event. It should be noted that the SAE detection circuitry 400, the harmonic distortion calculator 410, the minima tracker 412, the peak tracker 414, and the SAE detector 416 may be implemented as circuitry (e.g., on an application specific integrated circuit (ASIC) or field programmable gate array (FPGA)) or as software operations executing on the processor 186 of the computing system 182 (e.g., via instructions stored in a non-transitory computer-readable medium such as random access memory (RAM), read-only memory (ROM), rewritable non-volatile memory such as flash memory, hard drives, optical discs, or the like).

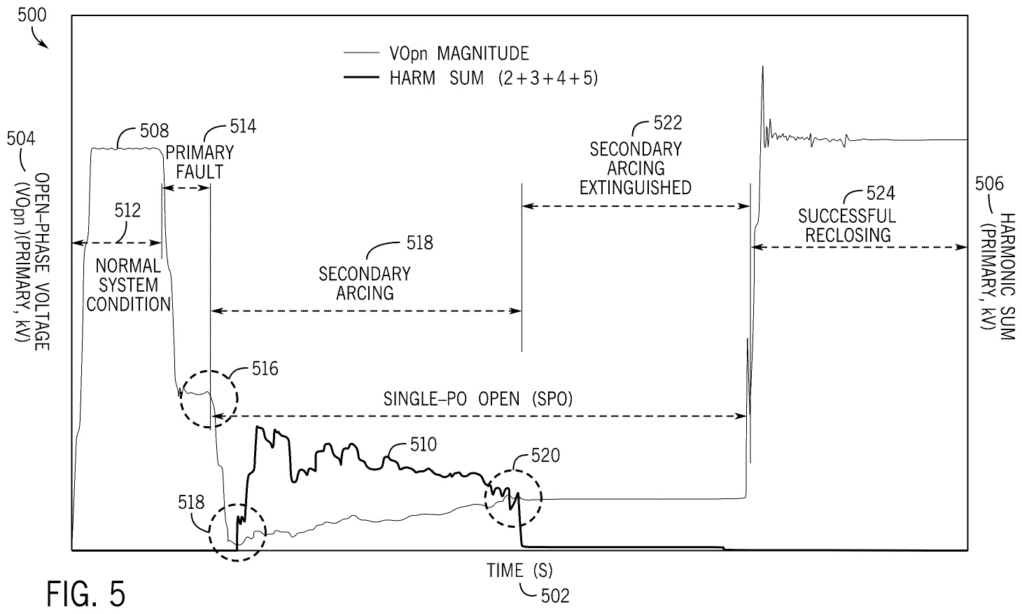

FIG. 5 includes a plot 500 that illustrates the underlying principle of SAE detection for uncompensated transmission lines (e.g., the uncompensated transmission line 300). The plot 500 includes an x-axis 502 representing time in seconds(s), a first y-axis 504 representing open phase voltage (VOpn) in kilovolts (kV), and a second y-axis 506 representing the root-mean-square (rms) sum of the second through fifth harmonics of the open phase. The plot includes a trace 508 representing the fundamental frequency voltage magnitude of the open phase (e.g., the A-phase 302) and a trace 510 representing the rms sum of the second through fifth harmonics. In some instances, the open-phase voltage (e.g., represented by the trace 508) may be filtered to extract the fundamental frequency magnitude and its second through fifth harmonic components. The fundamental frequency magnitude undergoes further processing through a first-order, low-pass Butterworth filter, which effectively attenuates higher frequency components so the SAE detection circuitry (e.g., SAE detection algorithm) can work with the underlying trends in the signals. This filtering process may be used with compensated and/or uncompensated transmission lines.

At time 512, the electric power delivery system 100 is in normal condition (e.g., no fault has occurred). At time 514, a primary fault occurs. The primary fault may be caused by a lightning strike, a surge, a foreign object coming into contact with exposed transmission lines, and so on. At time 516, the fault may be detected and a breaker may trip and open (e.g., blocking current from flowing downstream on the uncompensated transmission line 300) the faulted single phase, deenergizing the faulted phase. When the breaker trips at the time 516, the voltage represented by the trace 508 may drop precipitously (e.g., to or near 0 kV), which may, in some instances, indicate that a primary arc on the uncompensated transmission line 300 has been extinguished or has continued into a secondary arc. At the time 516, the SPO bit 404 may be asserted, and thus the SAE detection circuitry may be activated (e.g., operational).

As discussed above, current associated with a primary arc may be reduced and the primary arc may be converted to a secondary arc of lower current which may persist for a time 518. Secondary arcing refers to a sustained arcing through an ionized channel, which persists after the primary fault current has been cleared by isolating the faulted phase using single-pole tripping (SPT). The secondary arc may persist due to capacitive and inductive coupling from the healthy phases. For example, if the A-phase 302 is the faulted phase, the secondary arc may persist due to capacitive and inductive coupling from the B-phase 304 and/or the C-phase 306. The secondary arc extinguishes after a length of time has passed following the opening of the breaker.

To determine when that extinction occurs, the SAE detection circuitry 400, upon being activated based on receiving the asserted SPO bit 404, may begin tracking an open-phase voltage magnitude minimum via the minima tracker 412 starting at the time 516. Once a minimum is found, the minima tracker 412 outputs (e.g., asserts) a peak reset bit 413 to the peak tracker 414, which begins tracking the peaks of the open-phase voltage magnitude. The minima tracker 412 may reset each time a new minimum (e.g., smallest) open-phase voltage is detected, and likewise may cause the peak tracker 414 to reset upon assertion of the peak reset bit 413. Accordingly, at time 518, the minima tracker 412 may reset the minimum open-phase voltage to the voltage value present at the time 518 and cause the peak tracker 414 to reset and begin again tracking the peaks of the open-phase voltage, updating each time a new peak is determined and outputting the peak detection signal to the SAE detector 416. The peak of the open-phase voltage associated with the secondary arcing may occur, for example, at time 520. It should be noted that the peak tracker 414 and the minima tracker 412 may be analyzing a low-pass filtered version of the open-phase voltage magnitude.

The SAE detector 416 may receive an “update minimum” signal from the minima tracker 412, indicating that the minima tracker 412 has found a new minimum, and may receive an “update peak” signal from the peak tracker 414, indicating that the peak tracker 414 has found a new peak. The minima tracker 412 may output a high bit (e.g., 1, indicating that the update minimum bit 418 is asserted) or a low bit (e.g., the update minimum bit 418 is deasserted) every processing interval (e.g., 1 millisecond (ms)) depending on if a new minimum has been detected by the minima tracker 412. Similarly, the peak tracker 414 may output a high bit (e.g., the update peak bit 418 is asserted) or a low bit (e.g., 0, indicating that the update peak bit 420 is deasserted) depending on if a new peak has been detected by the peak tracker 414. However, if the SAE detector 416 receives or determines both the deasserted update minimum bit 418 and the deasserted update peak bit 420, the SAE detector 416 may output an SAE detection signal 428 indicating that the secondary arc has extinguished if all other conditions are met.

As may be observed, during secondary arcing at time 518, the harmonics (represented by the trace 510) are elevated but drop to zero or near-zero at the time of the extinction of the secondary arc at the time 520. Accordingly, the harmonic distortion calculator 410 may determine presence of the secondary arc based on whether the magnitude of the harmonic distortion is above or below a dynamically determined or predetermined harmonic distortion threshold. If the harmonic distortion is above the harmonic distortion threshold the harmonic distortion calculator 410 may output/assert a harmonic distortion high bit 422 to the SAE detector 416. If the SAE detector 416 receives the indication that the harmonic distortion is above the harmonic distortion threshold (e.g., via the asserted harmonic distortion high bit 422) the SAE detector 416 may output the block reclose signal 426 which may be transmitted from the SAE detection circuitry 400 to the recloser, causing the recloser to refrain from attempting to reclose as the secondary arc has not extinguished. However, if the harmonic distortion calculator 410 does not assert the harmonic distortion high bit 422 (e.g., deasserts the harmonic distortion high bit, outputs a 0) the SAE detector 416 may output the SAE detection signal 428, indicating that the secondary arc has been extinguished and that the recloser can reclose, assuming all other conditions for SAE detection have been met.

The magnitude comparator 408 may track the magnitude of the open-phase voltage to determine whether SAE has occurred. A magnitude check may differentiate an unfaulted state from a faulted state with no harmonics. A direct comparison between a voltage magnitude threshold and the open-phase voltage magnitude may not conclusively distinguish between the faulted and unfaulted state because the faulted voltage magnitude may exceed the unfaulted voltage magnitude. To address this, the magnitude comparator 408 may determine a compensated open-phase voltage by subtracting half of a total induced electromagnetic voltage (VOpn_{EMTOTAL}) from the measured open-phase voltage, as is shown below in Equation 2. If the secondary arc is extinguished, this subtraction removes the electromagnetic component, leaving only the electrostatic component of the open-phase voltage. If the fault is bolted, the subtraction limits open-phase voltage to half of VOpn_{EMTOTAL} (which may be as high as the electrostatic component) after subtraction, a threshold of more than 50 percent of the estimated electrostatic component may provide a near comparison between the compensated voltages. The default threshold value may be 85 percent of the estimated electrostatic component. However, this is not limiting, and the threshold value may be set to any appropriate percentage of the estimated electrostatic component, such as 40 percent or less, 50 percent or less, 50 percent or more, 60 percent or more, 70 percent or more, 90 percent or more, and so on.

$${VOpn}_{EMTOTAL} = \{ \begin{matrix}{I}_{BS}^{′} * {Z}_{AB} + {I}_{CS}^{′} * {Z}_{CA} ( accurate ) \\ ( {I}_{BS}^{′} + {I}_{CS}^{′} ) * {Z}_{M} ( approximate )\end{matrix} \qquad ( Equation 1 )$$

$${VOpn}_{COMP} = {VOpn}_{MEAS} - \frac{{VOpn}_{EMTOTAL}}{2} \qquad ( Equation 2 )$$

$${VOpn}_{ESest} = \{ \begin{matrix}\frac{{V}_{Bavg} * {C}_{AB} + {V}_{Cavg} * {C}_{CA}}{{C}_{AA}} \\ \frac{{C}_{M} * ( {V}_{Bavg} + {V}_{Cavg )}}{{C}_{S}}\end{matrix} \qquad ( Equation 3 )$$

Wherein I′Bs refers to the charging-current and reactor-current compensated phase current on the B-phase 304, I′_{CS} refers to the charging-current and reactor-current compensated phase current on the C-phase 306, Z_{AB} refers to the mutual impedances between the A-phase 302 and the B-phase 304, Z_{CA} refers to the mutual impedances between the A-phase 302 and the C-phase 306, Z_{M} represents the mutual impedances between the phases, V_{B} AVG represents the average phase voltage on the B-phase 304, V_{C}_{_{AVG}} represents the average phase voltage of the C-phase 306, C_{CA} refers to mutual capacitance between the C-and A-phases, C_{AA} refers to the self-capacitance of the A-phase 302, C_{AB} refers to mutual capacitance between the A-and B-phases, C_{M} refers to mutual capacitance, and C_{S} refers to self-capacitance. C_{M} and C_{S} may include estimates which assume a transposed line. Z_{M} may include estimates which assume a transposed line.

The compensated magnitude, VOpn_{comp}, is compared to a default threshold (e.g., of 85 percent) of the estimated electrostatic voltage calculated in Equation 3. To calculate the magnitude check threshold, the chosen threshold percentage (e.g., 85 percent) is multiplied by VOpn_{ES}_{_{EST}}. When the compensated open-phase voltage is greater than the magnitude threshold, the magnitude comparator 408 asserts the magnitude threshold check high bit 424, and the SAE detector 416 receives the asserted bit. Receiving the asserted bit indicates to the SAE detector 416 that the SAE may have occurred, and the SAE detector 416 may, if all conditions for SAE detection are satisfied, output the SAE detection signal 428, which may permit reclosing. However, when the compensated open-phase voltage is less than the magnitude threshold, the magnitude comparator 408 will not assert the magnitude threshold check high bit 424, and the SAE detector 416 will output the block reclose signal 426, preventing the recloser from reclosing as the secondary arc has not extinguished.

Referring back to FIG. 5, at time 522, the secondary arc extinguishes. At a time after the time 522 (e.g., time 524), the recloser may attempt reclosing after receiving an indication from the SAE detector 416 of the SAE detection circuitry 400 that the secondary arc has been extinguished.

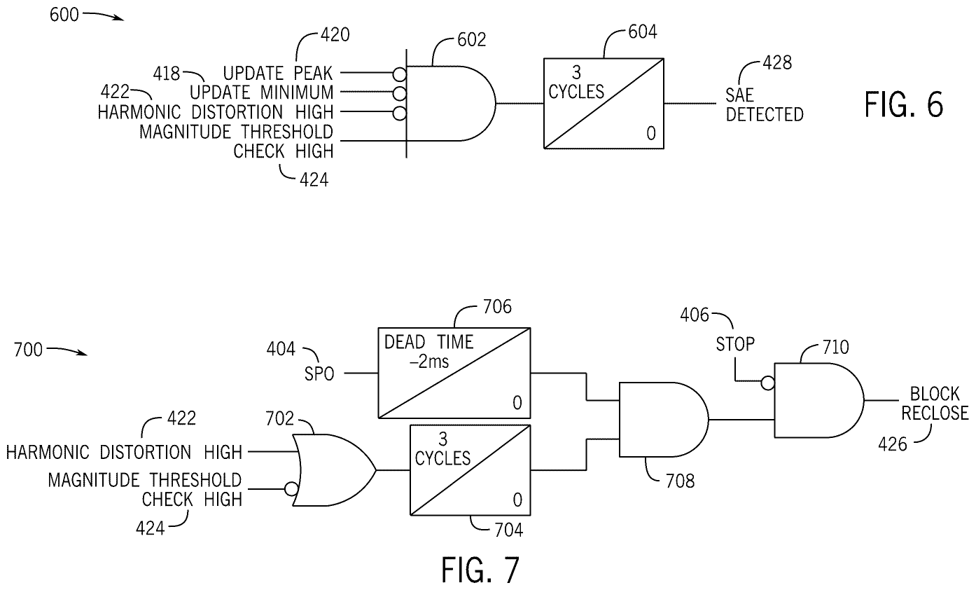

FIG. 6 is a logic diagram 600 of the SAE detector 400 illustrating the conditions under which the SAE detection circuitry 400 may output the SAE detection signal 428 and enable the recloser to reclose. As may be appreciated from the foregoing descriptions of FIGS. 4-5, the SAE detector 416 of the SAE detection circuitry may only output the SAE detection signal 428 if all conditions are met. These conditions include, to provide several non-limiting examples, the update peak bit 420 being low (e.g., deasserted), the update minimum bit 418 being low (e.g., deasserted), the harmonic distortion high bit 422 being low (e.g., deasserted), and the magnitude threshold check high bit 424 being high (e.g., asserted). All four bits described above may be input into an AND gate 602. A three-cycle delay 604 may ensure that the conditions do not result in a reclose being issued based on transients and that sufficient time is allowed after the SAE for dielectric strength buildup to withstand nominal system voltage. It should be noted that this is not limiting, and the delay cycle may be any appropriate length of time.

FIG. 7 is a logic diagram 700 of the SAE detector 416 illustrating the conditions under which the SAE detection circuitry 400 may output the block reclose signal 428 and prevent the recloser from reclosing. The harmonic distortion high bit 422 and an inverse (e.g., NOT) of the magnitude threshold check high bit 424 may be input into an OR gate 702. The output of the OR gate 702 may be input into a three-cycle delay circuit 704. That is, if either the harmonic distortion is high or the magnitude threshold check is low for at least three cycles (e.g., power system cycles), the logic indicates that either the secondary arc has not extinguished or the fault is permanent, and if the breaker recloses it will reclose onto the fault. As the output of a timing circuit 706 and the three-cycle delay circuit 704 are input into an AND gate 708, the SAE detection circuitry 400 determines if the harmonic distortion is high or if the magnitude threshold check has failed at two milliseconds (ms) prior to expiration of the dead time, as is indicated by the timing circuit 706. The output of the AND gate 708 is output to an AND gate 710, where it is ANDed with the stop bit 406. Consequently, if the arming logic 406 asserts the stop bit 406, the SAE detection circuitry 400 will be prevented from issuing the block reclose signal 426.

It should be noted that the block reclose signal 426 and the SAE detection signal 428 are not mutually exclusive. It is not possible for both outputs to be asserted simultaneously, but it is possible for both outputs to be deasserted simultaneously. Specifically, when the SAE detection conditions are met but the output is still timing. When neither the SAE detection signal 428 nor the block reclose signal 426 are asserted at the end of dead time, the reclose cycle may be extended by a short time to improve the chance of a successful reclose. Alternatively, the single-pole reclose may be converted to a three-pole trip and reclose.

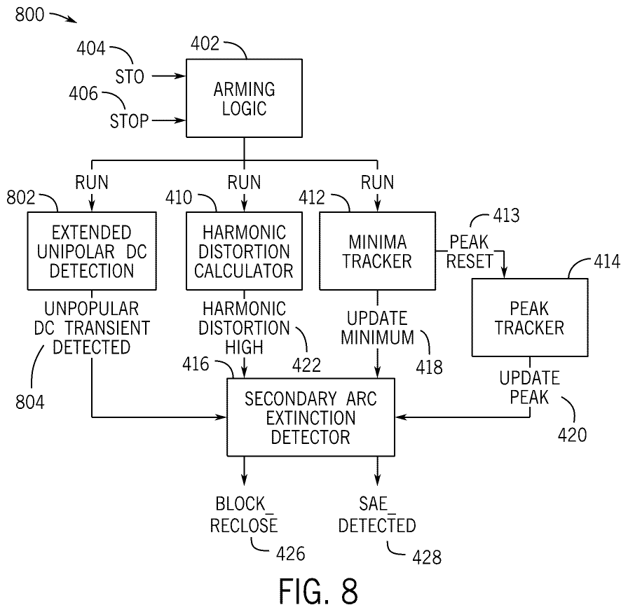

In other embodiments, SAE detection on uncompensated lines (e.g., the uncompensated transmission line 300) may be accomplished by monitoring direct current (DC) components in the open-phase voltage signal (e.g., 508). With this in mind, FIG. 8 is a flow diagram illustrating SAE detection circuitry 800 in an uncompensated transmission line using extended unipolar DC detection. As may be appreciated, the arming logic 402, the harmonic distortion calculator 410, the minima tracker 412, the peak tracker 414, and the SAE detector 416 are the same as or similar to the like components described with respect to FIGS. 4-7. The extended unipolar DC detector 802 may function to detect extended unipolar DC transient signals. When the secondary arc extinguishes, a DC transient may appear in the open-phase voltage. This DC transient decays with a transmission line RC time constant and, when applied to the primary of a voltage transformer, the DC transient may look like a second order under-damped response in the secondary voltage of the voltage transformer. This voltage transformer response to the primary transient may be detected (e.g., via the extended unipolar DC detector 802) by monitoring extended unipolar DC in the raw open-phase voltage signal. The period of unipolar DC can be as short as three quarters of a cycle or may extend longer than three cycles, depending on the voltage transformer.

If the extended unipolar DC detector 802 determines that a unipolar DC transient signal is present, the extended unipolar DC detector 802 may assert a unipolar DC transient high bit 804 and output the asserted bit to the SAE detector 416. The SAE detector 416 may output the SAE detection signal 428 based on receiving the asserted unipolar DC transient detected bit 804, assuming all other conditions for SAE detection are satisfied. If the extended unipolar DC detector 802 determines that a unipolar DC transient signal is not present, the extended unipolar DC detector 802 may not assert (e.g., may deassert) the unipolar DC transient high bit 804, in which case the SAE detector 416 may output the block reclose signal 426 and block the recloser from reclosing. The condition of the output bit can be latched since it is a transient that may not exist for the entire duration after secondary arc extinction. The latch may be reset after the breaker is reclosed or if harmonic activity is detected.

Accordingly, in the SAE detection circuitry 800, if the minima tracker 412 fails to find a new minimum, the peak tracker 414 fails to find a new peak, the harmonic distortion calculator 410 fails to detect harmonic distortion above a threshold, and the extended unipolar DC detection detects a unipolar CD transient, the SAE detector 416 may output the SAE detection signal 428 and enable the recloser to reclose. Otherwise, the SAE detector 416 may output the block reclose signal 426 and prevent the recloser from reclosing.

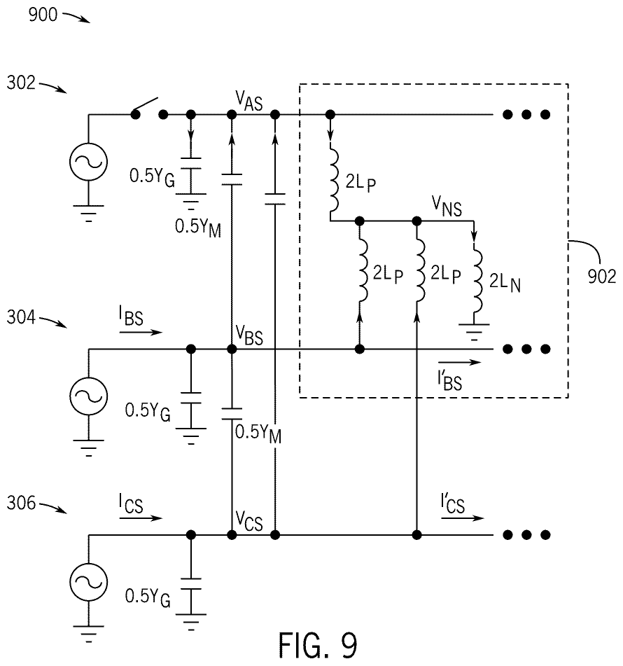

Secondary arc detection may also be performed for compensated transmission lines (e.g., shunt reactor-compensated transmission lines). FIG. 9 is a diagram of a compensated transmission line 900 having a four-legged shunt reactor 902. In FIG. 9, YG refers to phase-to-ground capacitive admittance, YM refers to mutual capacitive admittance, and Lp and LN refer to the phase and neutral reactor inductance, respectively. While only one half of the compensated transmission line 900 is shown for conciseness, it should be noted that a mirror image of what is shown in FIG. 9 may be implemented on the righthand side.

The uncompensated transmission line 300 and the compensated transmission line 900 may differ in several ways, and thus SAE detection may have to differ in certain instances. For example, referring to the compensated transmission line 900, the open-phase voltage magnitude after SAE consists of two components: a steady-state fundamental frequency component due to electrostatic(ES) and electromagnetic (EM) coupling from the other two phases and a transient oscillatory component due to resonance between the shunt reactors (e.g., 902) and the line capacitance. This transient oscillatory component is referred to herein as “ringing.” Because of the phasor creation process, the fundamental component shows up as a stationary phasor whereas the ringing component shows up as a rotating phasor with a beat frequency of the nominal frequency minus the ringing frequency (FNOM-FRING). Therefore, averaging the open-phase voltage phasor over one beat frequency cycle removes the ringing component. Instead of a magnitude comparator, a ringing detector may be utilized for the compensated transmission line 900 to determine if the secondary arc has extinguished.

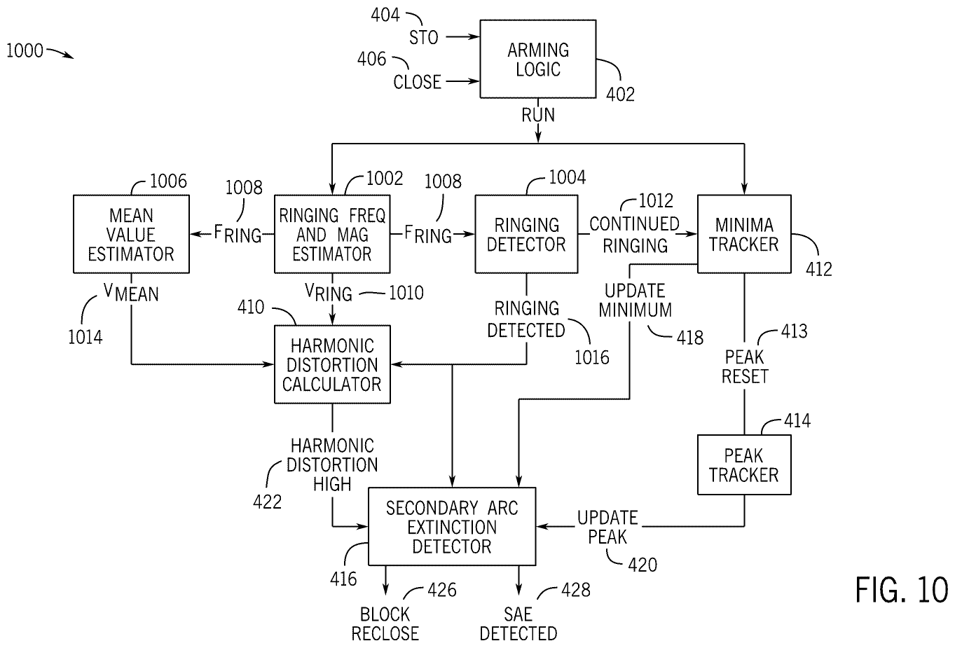

The ringing in the open-phase voltage may leak through the harmonic filtering and therefore may contribute to the harmonic distortion calculations of the harmonic distortion calculator 410. This leakage may cause the SAE detection circuitry to falsely assert the harmonic distortion high bit 422 (e.g., to assert that the harmonic distortion is above a threshold when it is not). The harmonic distortion calculator 410 may either remove the effect of leakage due to ringing or adapt the threshold to accommodate the increase in the harmonic distortion. The latter approach will be described with respect to FIG. 10 below.

FIG. 10 is a flow diagram for the operation of SAE detection circuitry 1000 for compensated transmission lines (e.g., the compensated transmission line 900). The SAE detection circuitry 1000 includes the arming logic 402, the minima tracker 412, the peak tracker 414, and the SAE detector 416, which may operate the same as or similar to the like components described above with respect to FIGS. 4-7. The harmonic distortion calculator 410 may calculate harmonic distortion based on inputs different than those described with respect to FIGS. 4-7, as will be discussed in greater detail below. In addition to the above-referenced components, the SAE detection circuitry 1000 includes the ringing frequency and magnitude estimator 1002, the ringing detector 1004, and the mean value estimator 1006.

As previously mentioned, a shunt reactor may be defined as reactor (e.g., an inductor) coupled between phase and ground. A reactor bank may be defined as a collection of reactors (e.g., inductors). Reactor banks may be disposed at each end of a transmission line. Calculating the amplitudes of the transient ringing component and the fundamental component of the open-phase voltage is crucial to adaptively update the harmonic threshold. When reactor banks (e.g., the shunt reactor 902) are installed at both ends of the line and one of these reactors is switchable, the ringing frequency will change depending on the reactor switch status. Instead of relying on fixed setting, the ringing frequency and magnitude estimator 1002 may measure the frequency and magnitude of the transient ringing component. To estimate the ringing component, the ringing frequency and magnitude estimator 1002 may use a differentiator-smoother filter to remove DC and 60 Hertz (Hz) fundamental voltage and its harmonics. After applying this filter, only the transient ringing portion of the open-phase voltage remains. The ringing frequency may be estimated by using zero-crossing detection on the cleaned signal. The ringing signal magnitude may be estimated by obtaining a quarter-cycle delayed sample and creating a phasor. Gain compensation from the filters may be used to obtain a magnitude of the ringing component in the open-phase voltage, VRING. The ringing frequency and magnitude estimator may output the ringing frequency (FRING) 1008 to the ringing detector 1004 and the mean value estimator 1006, and may output VRING 1010 to the harmonic distortion calculator 410.

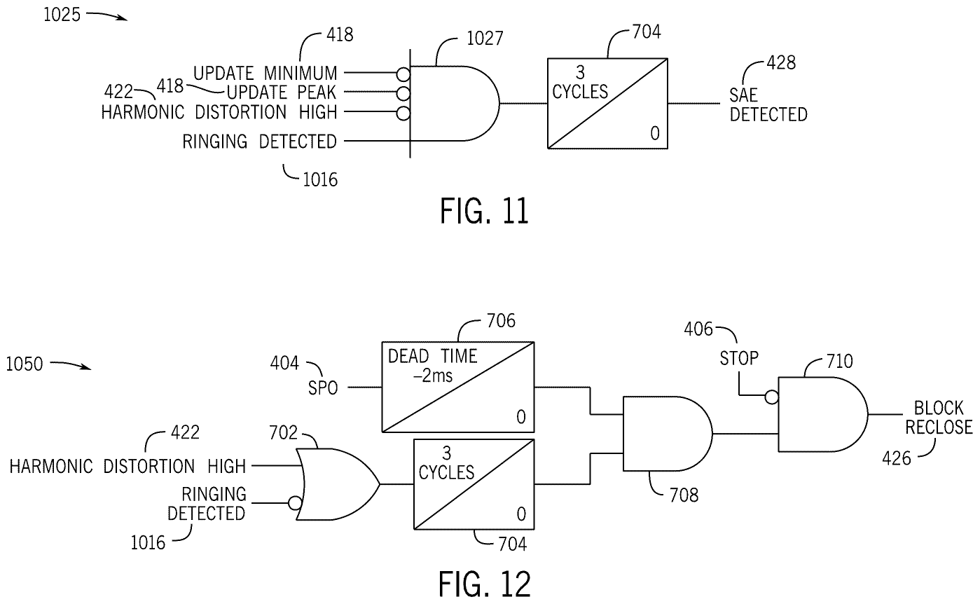

The ringing detector 1004 aids in differentiating between a bolted permanent fault and a secondary arc extinguished state. If the fault is bolted, no ringing will occur. If the secondary arc is extinguished, ringing will be present. In the absence of a magnitude check, the harmonics may serve as an indicator of the presence of an arcing fault. However, in scenarios with very-low-resistance faults, such as a bolted fault, harmonics might not be present. In such situations, ringing can be detected, latched on to, and used as an indicator that the secondary arc is extinguished. To detect ringing, the ringing detector may determine the frequency is within an expected range determined by typical shunt reactor compensation levels, and has a small deviation (e.g. 1 Hz) over the last 5 measurements. The ringing detector may output a continued ringing signal (e.g., assert a continued ringing bit 1012) to the minima tracker 412. The function of the continued ringing signal will be described below with respect to FIGS. 11-13.

FIG. 11 is a logic diagram 1025 of the SAE detector 416 illustrating the conditions under which the SAE detector 416 may output the SAE detected signal 428 and allow or enable the recloser to reclose (e.g., enable a circuit breaker to close) in the compensated transmission line 900. The logic diagram 1025 includes an AND gate 1027 taking in as inputs: an inverse (e.g., NOT) of the update minimum bit 418, an inverse (e.g., NOT) of the update peak bit 420, an inverse (e.g., NOT) of the harmonic distortion high bit 422, and the ringing detected signal 1016. That is, the AND gate 1027 will only output the SAE detected signal 428 (e.g., as a high output, 1) if the update minimum bit 418 is not asserted, the update peak bit 420 is not asserted, the harmonic distortion high bit 422 is not asserted (e.g., harmonic distortion does not exceed a dynamic harmonic distortion threshold), and if ringing is detected. Conversely, the AND gate 1027 will not output the SAE detected signal 428 (e.g., will output a low signal, 0) if the update minimum bit is asserted, the update peak bit 420 is asserted, the harmonic distortion high bit 422 is asserted, or if ringing is not detected. The output of the AND gate 1027 will be output to the three-cycle delay circuitry 704 (e.g., to ensure that the SAE detected signal 428 is not output based on transients). In this manner, the SAE detection logic represented by the logic diagram 1025 is configured to output the SAE detected signal 428 based on the update minimum bit 418, the update peak bit 420, the harmonic distortion high bit 422, and the ringing detected signal 1016.

FIG. 12 is a logic diagram 1050 of the SAE detector 416 illustrating the conditions under which the SAE detector 416 may output the block reclose signal 428 and prevent the recloser from reclosing in the compensated transmission line 900. The harmonic distortion high bit 422 and an inverse (e.g., NOT) of the ringing detected signal 1016 may be input into the OR gate 702. The output of the OR gate 702 may be input into the three-cycle (e.g., power system cycle) delay circuit 704. That is, if either the harmonic distortion is high or ringing detected signal 1016 is low (e.g., the ringing of the open-phase voltage is not detected) for at least three power system cycles, the logic indicates that either the secondary arc has not extinguished or the fault is permanent, and if the breaker recloses it will reclose onto the fault. As the output of the timing circuit 706 and the three-cycle delay circuit 704 are input into the AND gate 708, the SAE detection circuitry 400 determines if the harmonic distortion is high or if the ringing has not been detected at two milliseconds (ms) prior to expiration of the dead time, as is indicated by the timing circuit 706.

The output of the AND gate 708 is output to the AND gate 710, where it is ANDed with an inverted a stop bit 1052. When the arming logic issues the stop bit 1052, the block reclose signal 426 may be disabled. Consequently, if the arming logic 406 asserts the non-inverted stop bit 1052, the SAE detection circuitry 400 will be prevented from issuing the block reclose signal 426.

It should be noted that the block reclose signal 426 and the SAE detection signal 428 are not mutually exclusive. It is not possible for both outputs to be asserted simultaneously, but it is possible for both outputs to be deasserted simultaneously. Specifically, when the SAE detection conditions are met but the output is still timing. When neither the SAE detection signal 428 nor the block reclose signal 426 are asserted at the end of dead time, the reclose cycle may be extended by a short time to improve the chance of a successful reclose. Alternatively, the single-pole reclose may be converted to a three-pole trip and reclose.

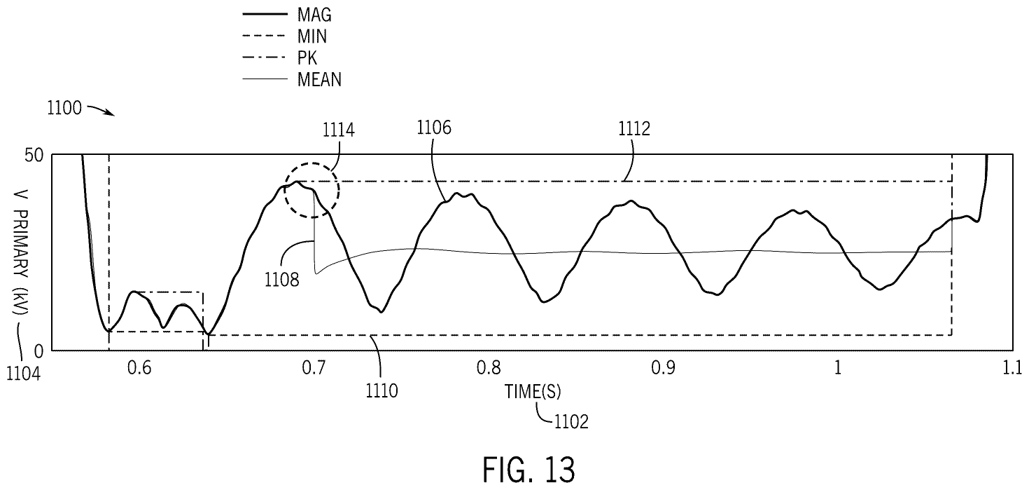

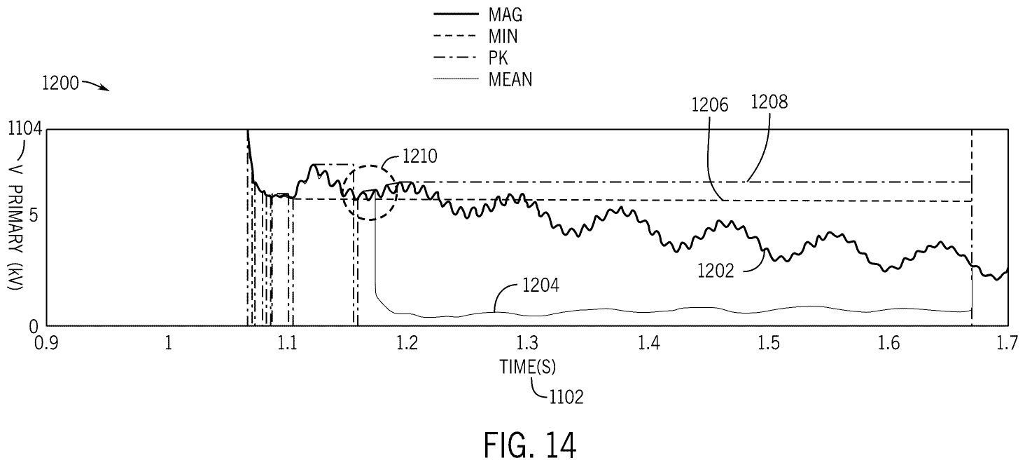

FIG. 13 is a plot 1100 illustrating the ringing of an open-phase voltage signal in a compensated transmission line (e.g., 900). The plot 1100 includes an x-axis illustrating time in seconds(s) and a y-axis illustrating primary voltage magnitude in kilovolts (kV). The plot 1100 shows the open-phase voltage 1106, a mean voltage 1108, a minimum voltage 1110, and a maximum voltage 1112. The secondary arc extinction may occur at a time prior to time 1114. At the time 1114 ringing may be detected, and/or the mean voltage 1108 drops in magnitude and becomes steady. In some instances like that shown in FIG. 13, the fundamental frequency magnitude may stay relatively consistent while the ringing of the open-phase voltage 1100 may s attenuate towards the mean 1102, such that no new peaks and no new minima are being detected, which correctly indicates that the SAE has occurred, assuming all other conditions are met.

However, in other instances,, the ringing of the open-phase voltage may consistently decrease, creating new minima, activating the minima tracker 404 and causing the SAE detection circuitry 416 to block reclosing when the SAE has extinguished. This may occur, for example, when shunt reactors closely match line capacitive admittance (e.g., due to use of a properly-sized neutral reactor), resulting in a very small fundamental frequency component for the open-phase voltage.

FIG. 14 is a plot 1200 illustrating this case. The plot 1200 includes the x-axis 1102 and the y-axis 1104 described with respect to FIG. 13, as well as an open-phase voltage 1202, a mean voltage 1204, a minimum voltage 1206, and a maximum voltage 1208. In the plot 1200, the SAE occurs at time 1210, and the mean 1204 drops to a steady state in response to the SAE. However, instead of riding the mean, such as the open-phase voltage 1106 does, open-phase voltage 1202 continues to steadily drop. This progressive voltage drop will cause the minima tracker 412 to reset its minimum, which will in turn reset the peak tracker 414, falsely indicating to the SAE detection circuitry 1000 that the SAE has not occurred. Accordingly, to prevent an incorrect minima tracker reset, the minima tracker 412 may pause minima tracking upon receiving the asserted continued ringing bit 1012 from the ringing detector 1004. The minima tracker 412 may be paused as long as ringing continues. As may be observed, the plot 1200 illustrates the scenario in which the minima tracker 412 is paused, as the minimum voltage 1206 does not update after the time 1210, and thus does not reset the peak tracker 414.

Returning to FIG. 10, the open-phase voltage phasor after SAE, by virtue of using a correlator for the phasor filter, consists of a static component (e.g., representing the fundamental frequency component) and an oscillatory component (e.g., oscillating at beat frequency because of the ringing component). The mean value, V_{MEAN} 1014, of the open-phase voltage phasor may represent the fundamental frequency voltage and is used as the threshold for the harmonic distortion comparison after ringing is detected. V_{MEAN} is extracted by passing the open-phase voltage phasor through an average filter designed to remove the beat frequency oscillations and measuring its magnitude. V_{MEAN}, in conjunction with the ringing voltage magnitude, V_{RING}, is used to adaptively (e.g., dynamically) adjust the harmonic threshold, as will be described below.

The harmonic distortion calculator 410 may operate similarly when implemented in the compensated transmission line 900 and the uncompensated transmission line 300. However, when implemented in the compensated transmission line 900, the harmonic distortion calculator 410 may account for ringing (e.g., the transitory oscillatory component of the open-phase voltage). When ringing leaks into the harmonic distortion calculation, the harmonics may become larger than the default threshold (e.g., 1 percent of V_{MEAN} or more, 5 percent of V_{MEAN} or more, 10 percent of V_{MEAN} or more, and so on) which may delay the algorithm from declaring that the SAE is detected until the ringing decays. To prevent this undesirable delay in SAE detection, the harmonic threshold (e.g., V_{HARMMEAS}) may be adaptively (e.g., dynamically) raised by a leakage factor, as shown in Equation 4 below.

$${V}_{HARMMEAS} > ( 0.05 ) * {V}_{MEAN} + LkgFact * {V}_{RING} \qquad ( Equation 4 )$$

Where LkgFact is the leakage factor used to account for the ringing leakage. Accordingly, it may be appreciated that the harmonic distortion calculator 410 receives as inputs V_{MEAN} 1014 V_{RING} 1010 to adjust the harmonic distortion threshold based on determining the presence of ringing (e.g., by receiving the ringing detected signal 1016, receiving an asserted ringing detected bit). The value of V_{MEAN} may take one cycle of the beat frequency to stabilize. Shunt reactor compensation levels may, in some instances, not exceed a threshold amount. For example, shunt reactor compensation levels may not exceed 75 percent (corresponding to 52 Hz ringing and 8 Hz beat frequency). While 75 percent is used as an example, it should be noted that any appropriate threshold may be used, such as more than 75 percent, 60 percent or more, 50percent or more, less than 50 percent, and so on. At 8 Hz, one cycle of beat frequency corresponds to 7.5 power system cycles of 60 Hz. Taking into account the three cycle (e.g., power system cycle) qualifying time, SAE can be detected in 10.5 power system cycles. For lower compensation levels, this time is shorter. When the ringing frequency is measured, the harmonic distortion calculator 410 may delay one beat frequency cycle before using V_{MEAN} in its calculation. Before V_{MEAN} stabilizes, the harmonic sum (determined by the harmonic distortion calculator 410) may be compared against a portion (e.g., 1 percent or more, 5 percent or more, 10 percent or more) of the minimum tracked value, VMIN. This may secure the SAE detection process by making the harmonic threshold sensitive until V_{MEAN} stabilizes.

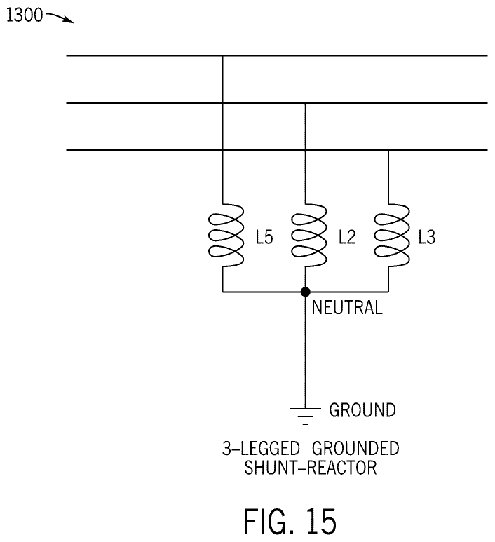

As mentioned above with respect to the compensated transmission line 900, some compensated transmission lines may include a four-legged shunt reactor (e.g., 902). However, SAE detection may be implemented for compensated transmission lines having shunt capacitors with any number and configuration of inductors. For example, SAE detection may be implemented for a 3-legged shunt reactor with a solidly grounded neutral, as illustrated in the shunt reactor 1300 of FIG. 15. The open-phase voltage in this situation can increase to very high voltage values after arc extinction. The higher the shunt reactor compensation, the higher the voltage and the higher the ringing frequency. At a certain point, the ringing frequency may begin nearing the nominal frequency and ringing detection can no longer be accomplished. However, voltage measurement exceeding a high voltage threshold may indicate that the arcing has extinguished.

This threshold may be set at 30 percent or more, 50 percent or more, 70 percent or more, or 90percent or more of the open-phase voltage maximum.

A combined approach may be implemented that enables three unique scenarios (uncompensated line, shunt-reactor compensated line with 4-legged reactors, and shunt-reactor compensated lines with 3-legged reactors) with their unique arc extinction signatures to be combined into one detection circuit. This may enable operable SAE detection circuitry regardless of whether the transmission line is uncompensated, compensated with 4-legged shunt reactors, or compensated with 3-legged shunt reactors.

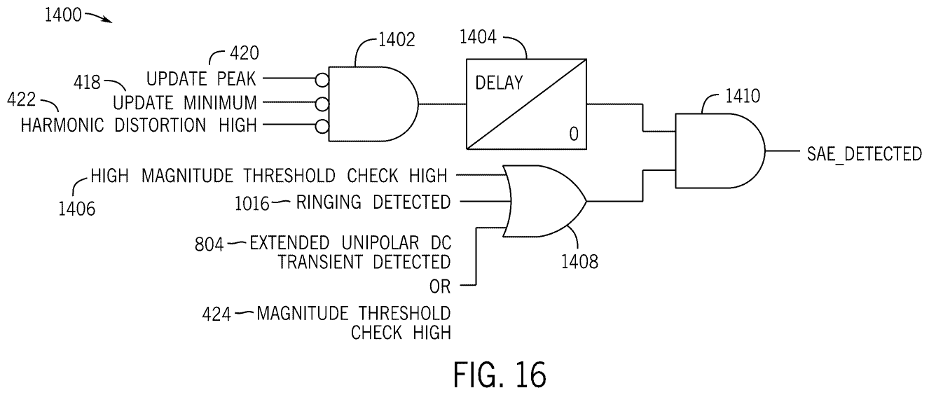

FIG. 16 includes a logic diagram 1400 illustrating a combined algorithm that enables SAE detection for uncompensated lines, shunt-reactor compensated lines with 4-legged reactors, and shunt-reactor compensated lines with 3-legged reactors. The logic diagram 1400 includes the update peak bit 420, the update minimum bit 418, and the harmonic distortion high bit 422 being inverted and inputting into an AND gate 1402, such that all bits must be low in order for the AND gate 1402 to output a high bit. That is, the peak tracker 414 and the minima tracker 412 do not update with a new peak or new minima for a threshold amount of time, as discussed with respect to FIGS. 4-6, and the harmonic distortion remains low. The output of the AND gate 1402 may be input into delay circuitry 1404 which may apply a delay (e.g., 3-cycle delay) to ensure that the conditions do not result in a reclose being issued based on transients. The delayed output of the AND gate 1402 may be input to the AND gate 1410.

The logic includes a high magnitude threshold check high bit that may be asserted when the open-phase voltage crosses a high magnitude threshold to account for SAE on transmission lines with the 3-legged shunt reactor 1300 of FIG. 15, wherein the open-phase voltage may increase to a very high voltage after SAE. The threshold associated with a high magnitude threshold check 1406 is higher than the voltage threshold associated with the uncompensated transmission line 300 and the SAE logic circuitry 400. For example, if the threshold associated with the magnitude threshold check 424 is 85% calculated electrostatic voltage, the threshold associated with the high magnitude threshold check 1406 may be greater than 85% (e.g., 86% or higher, 90% or higher, 95% or higher) of the nominal voltage (e.g., not calculated).

The logic includes the ringing detected bit 1016 as described with respect to FIGS. 10-12 to account for SAE in the compensated transmission line 900. The logic includes the unipolar DC transient detected bit 804, as described with respect to FIG. 8 and/or the magnitude threshold check high bit 424, which may both account for different aspects of an uncompensated transmission line (e.g., 300). If any of these bits/signals are input into the OR gate 1408, the OR gate 1408 will output a high bit to the AND gate 1410. If both the AND gate 1402 and the OR gate 1408 output high bits (e.g., 1 s), the AND gate 1410 will output a high bit (e.g., 1), indicating that the SAE has extinguished (e.g., via the SAE detection circuitry 416), and allowing a recloser to reclose. However, if either the AND gate 1402 or the OR gate 1408 output a low bit (e.g., 0), the AND gate 1410 will output a low bit (e.g., 0), indicating that the SAE has not extinguished (e.g., via the SAE detection circuitry 416) and blocking the recloser from reclosing. In this manner, the logic illustrated in the logic diagram 1400 may enable SAE detection for uncompensated transmission lines and compensated transmission lines, such as those compensated with 4-legged shunt reactors and/or 3-legged shunt reactors.

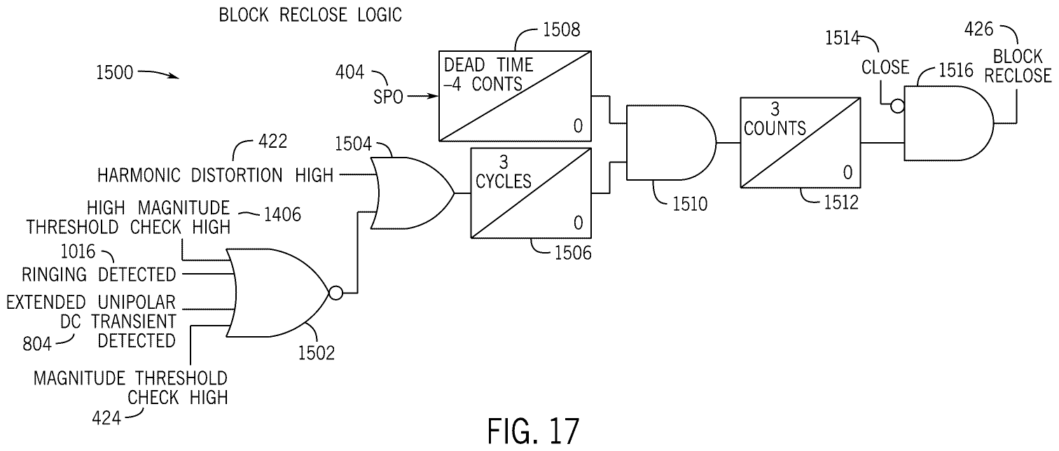

FIG. 17 is a logic diagram 1500 illustrating a combined algorithm that may block reclosing for uncompensated lines, shunt-reactor compensated lines with 4-legged reactors, and shunt-reactor compensated lines with 3-legged reactors. The logic diagram 1500 includes a NOR gate 1502 that is configured to output a low bit (e.g., a 0) if any of the inputs are true. That is, if the high magnitude threshold check high bit 1406 is asserted (e.g., the open-phase voltage exceeds the high threshold); if ringing detected bit 1016 is high (e.g., if ringing is detected); if the extended unipolar DC transient detected bit 804 is high (e.g., if the extended unipolar DC transient is detected); or if (in an uncompensated transmission line) the magnitude threshold check high bit 424 is asserted (e.g., if the open-phase voltage exceeds a lower threshold than the high threshold), then a low bit (e.g., 0) will be output from the NOR gate 1502. The NOR gate 1502 will output a high bit (e.g., a 1) if all input conditions are low.

The output of the NOR gate 1502 may be input into an OR gate 1504 along with the harmonic distortion high bit 422, such that if the harmonic distortion is low (e.g., at or below a harmonic distortion threshold), a low bit (e.g., 0) will be input to the OR gate 1504 and if the harmonic distortion is high (e.g., above the harmonic distortion threshold), a high bit (e.g., 1) will be input to the OR gate 1504. If either the harmonic distortion high bit 422 is asserted or all of the inputs to the NOR gate 1502 are low (e.g., the output of the NOR gate 1502 is high), the OR gate 1504 will output a high bit (e.g., 1). The output of the OR gate 1504 may be output to delay circuitry 1506 that may delay the output by a predetermined number of power system cycles. Delay circuitry 1508 may output the SPT bit 404 near the end of dead time (e.g., 4 counts prior to dead time) to check if any of the conditions discussed above have been true for the predetermined number of power system cycles (e.g., 3 cycles). The output of the delay circuitry 1508 and the delay circuitry 1506 may be input into the AND gate 1510. If both inputs into the AND gate 1510 are true, the AND gate 1510 will output a high bit (e.g., 1) to delay circuitry 1512 to check for security for a predetermined amount of time (e.g., 3 counts) before asserting the block reclose bit 426. The output of the delay circuitry 1512 may be ANDed with a NOT of a close bit 1514 to determine if the recloser is attempting to reclose. If the above discussed conditions are met, the logic of the logic diagram 1500 may block reclosing.

While specific embodiments and applications of the disclosure have been illustrated and described, it is to be noted that the disclosure is not limited to the precise configurations and devices disclosed herein. For example, the systems and methods described herein may be applied to an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be noted that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). For any claims containing elements designated in any other manner, however, it is intended that such elements are not to be interpreted under 35 U.S.C. 112(f).

What is claimed is:

1. An electric power protection system, comprising:
a recloser;
an intelligent electronic device (IED) communicatively coupled to the recloser, the IED comprising:
data acquisition circuitry configured to obtain a voltage signal of an electric power delivery system;
peak detection circuitry configured to determine a first voltage comprising a voltage peak;
minima detection circuitry configured to determine a second voltage comprising a voltage minimum;
arc extinction detection circuitry configured to determine that a secondary arc extinction has occurred based on:
determining that the first voltage remains the voltage peak; and
determining that the second voltage remains the voltage minimum.

2. The electric power protection system of claim 1, comprising harmonic distortion calculation circuitry configured to determine a harmonic distortion associated with the voltage signal.

3. The electric power protection system of claim 2, wherein the arc extinction detection circuitry is configured to determine that the secondary arc has extinguished based on determining that the harmonic distortion associated with the voltage signal is below a harmonic distortion threshold that is a dynamically-determined percentage of open-phase voltage magnitude.

4. The electric power protection system of claim 1, comprising voltage calculation circuitry configured to determine an open-phase voltage magnitude on a faulted phase of the electric power protection system.

5. The electric power protection system of claim 4, wherein the arc extinction detection circuitry is configured to determine a secondary arc has extinguished based on determining that a compensated open-phase voltage magnitude is greater than a dynamic voltage threshold.

6. The electric power protection system of claim 1, wherein the recloser is configured to reclose based on an indication from the arc extinction detection circuitry that the secondary arc has been extinguished.

7. The electric power protection system of claim 1, wherein the recloser is configured to refrain from reclosing based on an indication from the arc extinction detection circuitry that the secondary arc has not been extinguished.

8. The electric power protection system of claim 1, wherein the arc extinction detection circuitry is configured to determine that the secondary arc has been extinguished based at least partially on determining an extended unipolar direct current (DC) transient.

9. An electronic device, comprising:
data acquisition circuitry configured to obtain a voltage signal from an electric power delivery system;
harmonic distortion calculation circuitry configured to:
receive a transitory oscillatory component of a voltage signal;
receive a mean value of the voltage signal; and
determine whether harmonic distortion associated with the voltage signal exceeds a dynamically determined harmonic distortion threshold based on the transitory oscillatory component of the voltage signal and the mean value of the voltage signal; and
arc extinction detection circuitry configured to determine that a secondary arc in a transmission line of the electric power delivery system has not extinguished based at least on the harmonic distortion being below the dynamically determined harmonic distortion threshold.

10. The electronic device of claim 9, comprising:
peak detection circuitry configured to determine a first voltage of the voltage signal comprising a voltage peak; and
minima detection circuitry configured to determine a second voltage of the voltage signal comprising a voltage minimum.

11. The electronic device of claim 10, wherein the arc extinction detection circuitry is configured to determine that the secondary arc has been extinguished based at least partially on:
determining that the first voltage remains the voltage peak; and
determining that the second voltage remains the voltage minimum.

12. The electronic device of claim 11, wherein the minima detection circuitry is configured to refrain from determining the voltage minimum based on receiving an indication of the transitory oscillatory component of a voltage signal.

13. The electronic device of claim 11, wherein the arc extinction detection circuitry is configured to determine that the secondary arc has been extinguished based at least partially on determining that a first open-phase voltage exceeds a voltage threshold.

14. The electronic device of claim 9, wherein the arc extinction detection circuitry is configured to block a recloser from reclosing based on determining that the secondary arc in the electric power delivery system has not extinguished.

15. The electronic device of claim 9, wherein the electric power delivery system comprises a shunt reactor, the shunt reactor comprising a plurality of inductors coupled between a first line and a second line of the electric power delivery system.

16. The electronic device of claim 15, wherein the plurality of inductors comprises three inductors.

17. The electronic device of claim 15, wherein the plurality of inductors comprises four inductors.

18. A tangible, non-transitory, computer-readable medium comprising computer-readable instructions that, when executed, cause one or more processors to:
obtain a voltage signal from a transmission line;
determine a first voltage level of the voltage signal comprising a voltage peak;
determine a second voltage level of the voltage signal comprising a voltage minimum;
determine a secondary arc has extinguished based on:
determining that the first voltage level remains the voltage peak; and
determining that the second voltage level remains the voltage minimum.

19. The tangible, non-transitory, computer-readable medium of claim 18, wherein the computer-readable instructions, when executed, cause the one or more processors to determine a harmonic distortion associated with the voltage signal.

20. The tangible, non-transitory, computer-readable medium of claim 19, wherein the computer-readable instructions, when executed, determine that the secondary arc has extinguished based on determining that the harmonic distortion associated with the voltage signal is below a dynamically determined harmonic distortion threshold.
